(19) United States
(12) Patent Application Publication
(10) Pub. No.: US 2015/0238820 A1
(43) Pub. Date: Aug. 27, 2015

(54) MULTI-FOAM LAYERS EXERCISE DEVICE AND METHOD FOR USING SAME

(71) Applicant: Palziv Ltd., Kibbutz Ein Hanatziv (IL)

(72) Inventors: Marvin LANGER, Ein Hanatziv (IL); Ofir ATEL, Bet Shaan (IL); Ben Zion APPEL, Ein Hanatziv (IL); Benjamin Joshua REISMAN, Halamish (IL)

(73) Assignee: Palziv Ltd., Kibutz Ein Hanatziv (IL)

(21) Appl. No.: 14/187,449

(22) Filed: Feb. 24, 2014

(51) Int. Cl. A63B 26/00; B32B 7/06; B32B 7/02; B32B 5/32

(52) U.S. Cl. CPC A63B 26/003; B32B 5/32; B32B 7/06; B32B 7/02; B32B 2250/22; B32B 2307/536

(57) ABSTRACT

An exercise device comprising a first foam layer and a second foam layer; wherein the first foam layer has a thickness of between 10% and 35% of the thickness of the exercise device, a Shore 00 value of between 60 and 85; and a compression deflection at 25% of from 100 to 145 kiloPascal; and the second foam layer has a thickness of between 65% and 90% of the height of the exercise device; a Shore 00 value of between 35 and 65; and a compression deflection at 25% between 20 and 75 kiloPascal. The exercise device may further comprise a third foam layer; the third foam layer may have a convex external horizontal side. According to some embodiments, the third foam layer may be detachable affixed to the exercise device. A method for using the exercise device is also disclosed.

### BACKGROUND OF THE INVENTION

Multi-purpose training and exercise devices are common for domestic use, as well as in gyms and sports arenas. However, most multi-purpose exercise device are limited in their range of uses, and are bulky and hard to modify for different types of exercises. For example, most multi-purpose exercise devices are directed either for aerobic exercises or for strength exercises.

### SUMMARY OF THE INVENTION

Embodiments of the invention provide an exercise device having a first foam layer on a first horizontal side of the exercise device and a second foam layer on a second horizontal side of the exercise device; where the first foam layer has a thickness of between 10% and 35% of the height of the exercise device, a Shore 00 value of between 60 and 85; and a compression deflection at 25% of from 100 kiloPascal and 145 kiloPascal; and the second foam layer has a thickness of between 65% and 90% of the height of the exercise device; a Shore 00 value of between 35 and 65; and a compression deflection at 25% between 20 kiloPascal and 75 kiloPascal; and where the exercise device has a height of between 80 millimeters and 250 millimeters.

According to some embodiments, the first foam layer and the second foam layer may have substantially the same width and length dimensions. The width may be, for example, between 25 centimeters and 50 centimeters, and the length may be, for example, between 50 centimeters and 150 centimeters.

The first foam layer may have a first color, and the second foam layer may have a second color.

The external horizontal layer (when the exercise device is in use) of each of the first foam layer and the second foam layer may be substantially flat.

According to some embodiments, the first foam layer may be fixed to the second foam layer. According to other embodiments, the first foam layer may be detachably affixed to the second foam layer.

The exercise device may further have a third foam layer, the third foam layer may have a convex external horizontal side. According to some embodiments, the third foam layer may be detachably affixed to the exercise device.

The third foam layer may have a Shore 00 value of between 60 and 90; and a compression deflection at 25% between 90 kilo Pascal and 250 kilo Pascal.

Embodiments of the present invention further provide a method for using a multi foam layer exercise device. The method may include providing a first foam layer; providing a second foam layer; attaching the first foam layer to the second foam layer; and placing the exercise device on a rigid surface so that only one of the first foam layer and the second foam layer may be in contact with the rigid surface.

The method may further include attaching a third foam layer to the first foam layer. The third foam layer may have a flat face and a convex face; and the flat face may be detachably attached to the first layer. The convex face may be on an external horizontal side of the third foam layer. The third foam layer may be detachably affixed to the exercise device.

### BRIEF INSCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic, exploded illustration of an exercise device, according to some embodiments of the present invention;

FIG. 2 is a schematic illustration of the exercise device of FIG. 1 in an attached form;

FIGS. 3A and 3B illustrate an exercise device comprising a layer having a convex external horizontal side in a detached form and in an attached form, according to some embodiments of the present invention;

FIGS. 4A and 4B are schematic illustrations of an exercise device according to some embodiments, in an isometric view and in a cross section;

FIG. 4C is a schematic illustration of an exercise device with unsmooth portions for slipping prevention; and

FIG. 5 is a flow diagram of a method of using an exercise device according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

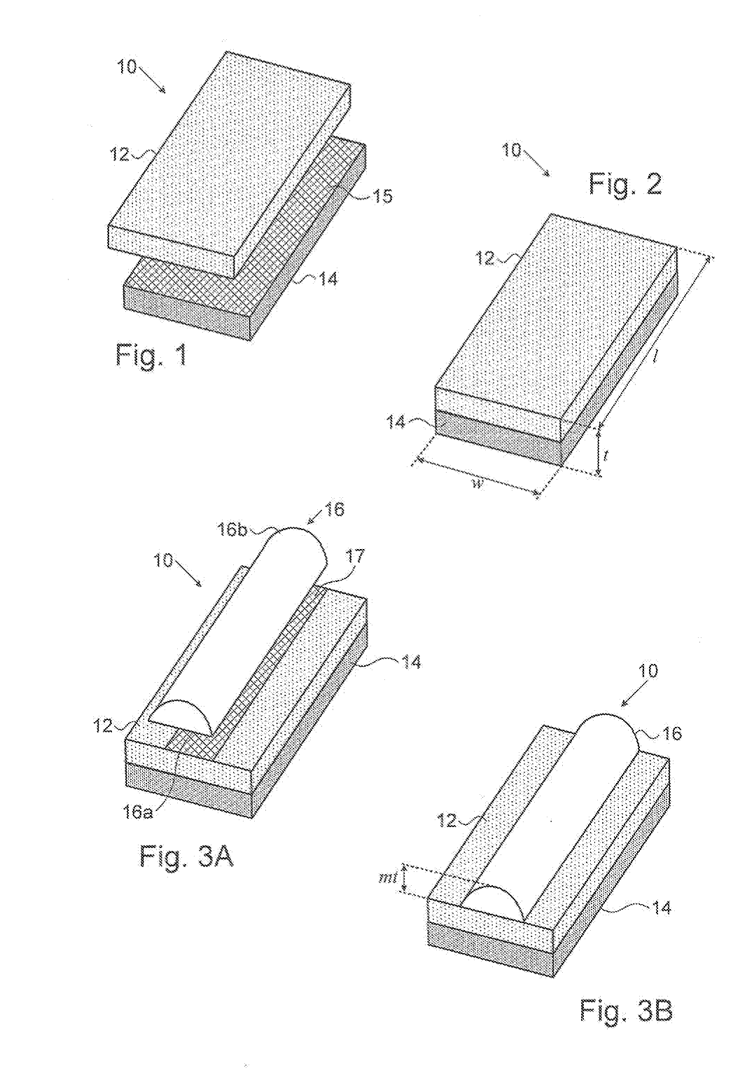

Reference is now made to FIGS. 1 and 2 which illustrate an exercise device 10 according to some embodiments of the present invention. Exercise device 10 may comprise a first foam layer 12 and a second foam layer 14. First foam layer 12 and second foam layer 14 may be attached to each other so that a side of first foam layer 12 defined by the two longest dimensions of first foam layer 12 is attached to a side of second foam layer 14 defined by the two longest dimensions of second foam layer 14.

According to some embodiments, first foam layer 12 may be affixed to second foam layer 14 in a detachable form, such as by means of hook and loop fastener 15 (e.g., Velcro®) so that the hooks side of fastener 15 is attached to a first side of one foam layer 12 or 14 and the loops side of fastener 15 is attached to a second side of the other foam layer 12 or 14 so that when layer 12 and layer 14 are attached to each other, the hooks side of fastener 15 and the loops side of fastener 15 should be facing each other.

It should be appreciated that other detachable affixing means may be used such as buttons, zippers and any other detachable affixing means known in the art.

According to some embodiments of the present invention, first foam layer 12 may be affixed to second foam layer 14 in a non-detachable manner, such as by means of adhesive.

First foam layer 12 may have a thickness of between 10% and 35% of the entire thickness of exercise device 10, and may have a Shore 00 value of between 60 and 85; and a compression deflection at 25% in the range of 100 kiloPascal (kPa) and 145 kPa.

First foam layer 12 may be made of a polyethylene foam block, such as Palziv Palfoam PB65, having a density of 65 Kg/m³, compression deflection at 25% of 132 kPa and a Shore 00 value of 70. It should be appreciated that other foamed polymers may be used.

According to some embodiments, second foam layer 14 may be softer than first foam layer 12. Second foam layer 14 may have a thickness of between 65% and 90% of the entire thickness of exercise device 10. Second foam layer 14 may have a Shore 00 value of between 30 and 65; and a compression deflection at 25% in the range of 20 kPa and 75 kPa.

Second foam layer 14 may be made of polyethylene foam block, such as Palziv Palfoam PA30 having a density of 30 Kg/m³, compression deflection at 25% of 62 kPa and a Shore 00 value of 54. It should be appreciated by those skilled in the art that other foamed polymers may be used.

According to some embodiments, in order to ensure that first layer 12 is harder than second foam layer 14, a minimum difference between the shore 00 values of first layer 12 and second layer 14 may be set. For example, first foam layer 12 may have a Shore 00 value that is 15 points higher than the Shore 00 value of second foam layer 14, on the shore 00 scale. According to other embodiments, first foam layer 12 may have a Shore 00 value of between 65 and 85 and second foam layer 14 may have a Shore 00 value in the range of 35 and 55.

According to some embodiments, first foam layer 12 and second foam layer 14 may have substantially identical length l and width w. Length l, according to some embodiments may be in the range of 80 cm and 300 cm. Width w may be in the range of 80 cm and 300 cm. Thickness t of exercise device 10 may be in the range of 8 cm and 25 cm. It should be appreciated that other dimensions for length l, width w and thickness t may be used.

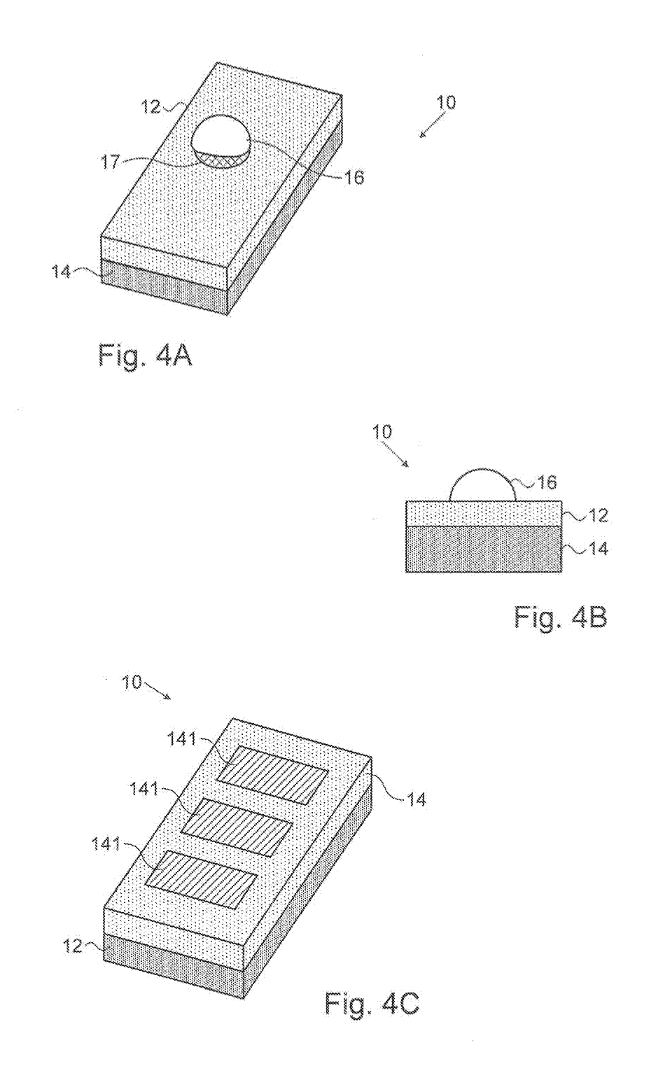

Reference is now made to FIGS. 3A, 3B, 4A and 4B. Exercise device 10 may comprise a third foam layer 16. According to some embodiments, third foam layer 16 may have a convex face 16b and a flat face 16a. Third foam layer 16 may be shaped as a half cylinder (as seen in FIGS. 3A and 3B) or a half globe (as seen in FIG. 4A). Flat fact 16a may be affixed, in a detachable form, to an outer face of first foam layer 12, opposite to the face of first foam layer 12 attached to second foam layer 14.

According to some embodiments, third foam layer 16 may be attached to first foam layer 12 by means of hook and loop fastener 17 or by any other detachable affixing means known in the art. According to other embodiments, third foam layer 16 may be attached to first foam layer 12 in a non-detachable manner, e.g., by means of adhesives.

Third foam layer 16 may be harder than first foam layer 12. Third foam layer 16 may have a maximal thickness mt in the range of 2 cm to 25 cm. Third foam layer 16 may have a length that is equal to or smaller than length l of exercise device 10, and may have a width that is equal to or smaller than width w of exercise device 10. Third foam layer 16 may have a Shore 00 value of between 60 and 90; and a compression deflection at 25% in the range of 90 kPa and 250 kPa.

Third foam layer 16 may be made of polyethylene foam block, such as Palziv Palfoam PA125 having a density of 125 Kg/m³, compression deflection at 25% of 225 kPa and a Shore 00 value of 79. It should be appreciated by those skilled in the art that other foamed polymers may be used.

With reference to FIG. 4C, exercise device 10 may further comprise, according to an embodiment of the present invention, one or more unsmooth portions 141 on at least one side of foam layer 14, facing away from foam layer 12 when foam layers 12 and 14 are attached. Unsmooth portions 141 may be embossments of or grooves in foam layer 14, or may be separate layers of rough material, detachably connected to foam layer 14.

It should be appreciated that in addition or alternatively, unsmooth portions 141 may be created or attached on an outer side of foam layer 12.

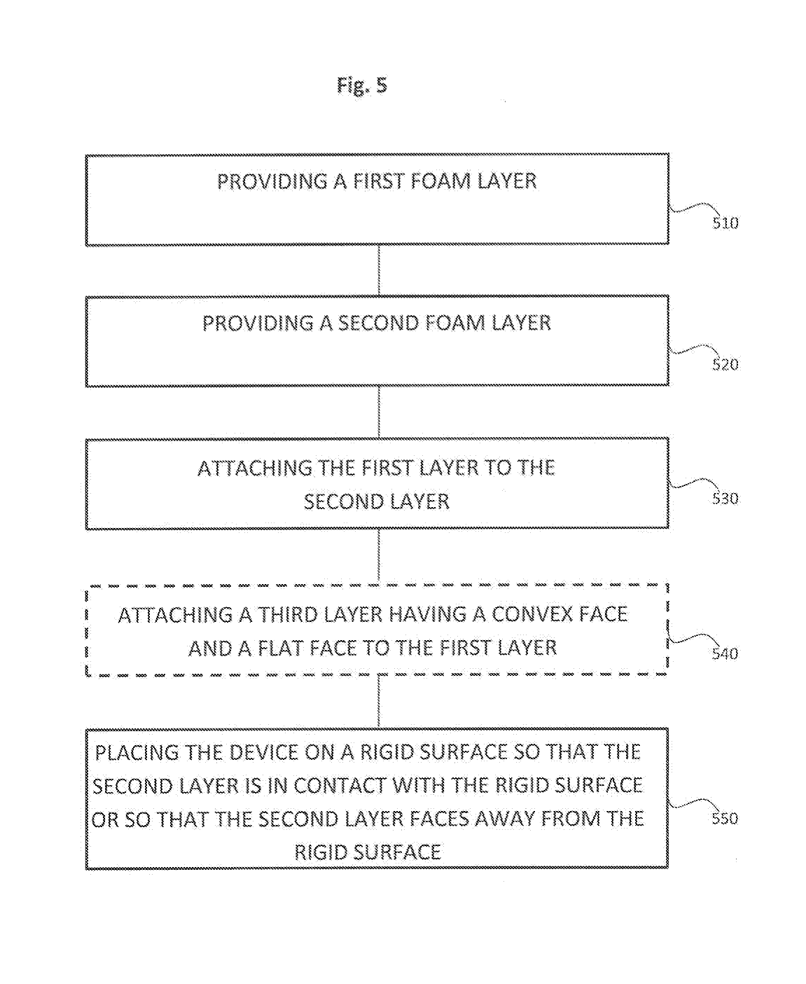

Reference is now made to FIG. 5 which is a flowchart of a method for using an exercise device according to some embodiments of the present invention. The method may comprise providing a first foam layer (block 510); providing a second foam layer (block 520); where the first foam layer is harder than the second foam layer.

The method may further comprise attaching the first layer to the second layer to be partially or fully overlapping (block 530). According to some embodiments, the attaching of the first layer to the second layer may be in a detachable manner, e.g., by hook and loop fasteners, by means of buttons, zippers and the like.

Optionally, a third layer, having a convex face and a flat face, may be attached to the first layer along the flat face of the third layer (block 540). It should be appreciated that the third layer may be attached in a detachable or non-detachable manner to the first layer.

After the first and second layers and optionally the third layer are attached, the exercise device may be placed on a rigid surface so that the second layer is in contact with the rigid surface or so that the second layer faces away from the rigid surface (block 550). The exercise device's position is determined according to the specific exercise or set of exercises that should be done.

For example, when a balance exercise is required, the third layer may be attached and the exercise device may be places on a rigid surface such as a floor with the convex face of the third layer facing the surface, and the second layer facing substantially away from the rigid surface. In another example, the exercise device may be used as an aerobic step. In this example, the third layer may not be attached or may be removed, and the exercise device may be placed with the softer layer (i.e., the second layer) facing the rigid surface.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An exercise device comprising:
a first foam layer on a first horizontal side of the exercise device and a second foam layer on a second horizontal side of the exercise device;
wherein
said first foam layer has
(i) a thickness of between 10% and 35% of the height of the exercise device,
(ii) a Shore 00 value of between 60 and 85; and
(iii) a compression deflection at 25% of from 100 kiloPascal and 145 kiloPascal; and
said second foam layer has
(i) a thickness of between 65% and 90% of the height of the exercise device;
(ii) a Shore 00 value of between 35 and 65; and
(iii) a compression deflection at 25% between 20 kiloPascal and 75 kiloPascal; and
wherein said exercise device has a height of between 80 millimeters and 250 millimeters.

2. The exercise device as in claim 1, wherein said first foam layer and said second foam layer have substantially the same width and length dimensions, wherein said width is between 25 centimeters and 50 centimeters, and said length is between 50 centimeters and 150 centimeters.

3. The exercise device as in claim 1, wherein at least one of said first foam layer and said second foam layer have unsmooth portions on an external face thereof.

4. The exercise device as in claim 1, wherein an external horizontal layer of each of said first foam layer and said second foam layer are substantially flat.

5. The exercise device as in claim 1, wherein said first foam layer is fixed to said second foam layer.

6. The exercise device as in claim 1, wherein said first foam layer is detachable affixed to said second foam layer.

7. The exercise device as in claim 1 comprising a third foam layer, said third foam layer having a convex external horizontal side.

8. The exercise device as in claim 7, wherein said third foam layer is detachably affixed to said exercise device.

9. The exercise device as in claim 7 wherein said third form layer has
(i) a Shore 00 value of between 60 and 90; and
(ii) a compression deflection at 25% between 90 kiloPascal and 250 kiloPascal.

10. A method for using a multi foam layers exercise device comprising:
providing a first foam layer;
providing a second foam layer;
attaching said first foam layer to said second foam layer; and
placing said exercise device of a rigid surface so that only one of said first foam layer and said second foam layer is in contact with said rigid surface.

11. The method according to claim 10 further comprising attaching a third foam layer to said first foam layer; wherein said third foam layer has a flat face and a convex face; and wherein said flat face is detachably attached to said first layer.

12. The method according to claim 10 wherein said first foam layer has
(i) a thickness of between 10% and 35% of the height of the exercise device,
(ii) a Shore 00 value of between 60 and 85; and
(iii) a compression deflection at 25% of from 100 kiloPascal and 145 kiloPascal; and
said second foam layer has
(i) a thickness of between 65% and 90% of the height of the exercise device;
(ii) a Shore 00 value of between 35 and 65; and
(iii) a compression deflection at 25% between 20 kiloPascal and 75 kiloPascal; and
wherein said exercise device has a thickness of between 80 millimeters and 250 millimeters.

13. The method according to claim 10 wherein said first foam layer and said second foam layer have substantially the same width and length dimensions, wherein said width is between 25 centimeters and 50 centimeters, and said length is between 50 centimeters and 150 centimeters.

14. The method according to claim 10, wherein an external horizontal layer of each of said first foam layer and said second foam layer are substantially flat.

15. The method according to claim 10, wherein said first foam layer is detachably affixed to said second foam layer.

16. The method according to claim 11 wherein said convex face is on an external horizontal side of said third foam layer.

17. The method according to claim 11, wherein said third foam layer is detachable affixed to said exercise device.

18. The method according to claim 11 wherein said third foam layer has
(i) a Shore 00 value of between 60 and 90; and
(ii) a compression deflection at 25% between 90 kiloPascal and 250 kiloPascal.

19. An exercise device comprising:
a first foam layer having three dimensions, said first foam layer having a first side defined by the two longest dimensions of said first foam layer; and
a second foam layer having three dimensions, said second foam layer having a second side defined by the two longest dimensions of said second foam layer;
wherein said first side of said first foam layer is attached to said second side of said second foam layer to define a thickness of said exercise device
wherein
said first foam layer has
(iv) a third dimension of between 10% and 35% of the thickness of the exercise device,
(v) a Shore 00 value of between 60 and 85; and
(vi) a compression deflection at 25% of from 100 kiloPascal and 145 kiloPascal; and
said second foam layer has
(iv) a third dimension of between 65% and 90% of the thickness of the exercise device;
(v) a shore 00 value of between 35 and 65; and
(vi) a compression deflection a 25% between 20 kiloPascal and 75 kiloPascal; and
wherein said thickness of said exercise device is between 80 millimeters and 250 millimeters.

20. The exercise device as in claim 19 further comprising a third foam layer, said third foam layer is detachably affixed to said first foam layer and have a convex external side; wherein said third foam layer has
(i) a Shore 00 value of between 60 and 90; and
(ii) a compression deflection at 25% between 90 kiloPascal and 250 kiloPascal.
